(19) United States
(12) Patent Application Publication
(10) Pub. No.: US 2008/0290031 A1
(43) Pub. Date: Nov. 27, 2008

(54) Spacer for Filter Modules

(75) Inventors: Gabriel Popa, Rodgau (DE); Jean Suidureau, Saint-Germain-en-Laye (FR); Petra Johannsen, Hamburg (DE); Georg Reinhold, Kelkheim (DE)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/577,116

(22) PCT Filed: Oct. 14, 2005
(86) PCT No.: PCT/EP05/11085

§ 371 Date: Mar. 11, 2008

Related U.S. Application Data
(60) Provisional application No. 60/618,586, filed on Oct. 15, 2004.

(51) Int. Cl. B01D 63/08; B01D 63/10; C02F 1/00; B32B 3/20

(52) U.S. Cl. 210/650; 210/321.84; 428/98; 428/188

(57) ABSTRACT

In order to provide a spacer for filter modules which may be used not only for plate and frame filter modules, but also for spiral wound-type filter modules and which allows high packing densities while providing optimized cleanability, a spacer for filter modules is proposed to be disposed between two layers of a filter medium, said spacer comprising an essentially flat structured sheet material having upper and lower projections on the upper and lower surfaces thereof, respectively, said upper and lower projections defining an upper and lower bearing face for the layers of filter medium, wherein said projections rise from said upper and lower surfaces with wall portions and terminate in top portions, said upper and lower projections being spaced from each other in a direction parallel to the surface of the sheet material.

The invention relates to a spacer for filter modules which is disposed between two layers of a filter medium, said spacer comprising an essentially flat structured sheet material having upper and lower projections on the upper and lower surfaces thereof. The upper and lower projections define an upper and lower bearing face for the layers of filter medium.

Such types of spacers are often used in open channel filter designs which, in particular, may be used where membranes form the filter medium. The spacers can be used in spiral wound-type or plate and frame modules for microfiltration, ultrafiltration, nanofiltration and reverse osmosis.

Such types of filter modules have been frequently used for the solution of filtration problems, for example, frequently in the treatment of industrial process water, treatment of leachate of landfills or desalination of sea water.

To date, spacers for plate and frame filter modules have been used in the form of rigid polymer discs on the surface of which a plurality of punctiform projections or ridges are formed, which serve as a support for the filter medium. A voids volume for inflowing fluid to be filtered is provided between the surface of the plastic discs and the filter medium.

The plate and frame filter modules are operated according to the principle of open channels, which means that the fluid is able to contact essentially the whole of the surface of the filter medium used. In fluid flow direction, there are no, or only small, obstacles to the fluid flow.

Because of the open channel technique used, plate and frame modules are not sensitive to fouling, however, they have a relatively low package density which raises the module costs when calculated on the basis of the filter medium surface actually available in comparison with the spiral wound-type filter modules.

In contrast to plate and frame modules, the spiral wound-type modules have heretofore been manufactured using a flexible spacer having a gridlike structure. The structure of these spacers is such that in the flow direction of the fluid to be filtered obstacles occur which lead to areas where the fluid flow is reduced and which are prone to cause collection of sediments.

Inside a spiral wound type filter module there generally may occur three different mechanisms of module blocking:
scaling, which is a result of the precipitation of salts whose concentration exceeds the precipitation concentration;
biofouling and
fouling, which both result in the settlement of sediments and/or bacterial growth.

Where the scaling can mostly be dissolved during cleaning, the fouling and biofouling layers of settlements have to be removed mechanically.

In addition, the webs of the gridlike structure of known modules form barriers which reduce or limit the possibility to regenerate the modules, since at least part of the deposit which has been removed by chemical cleaning and flushing of the filter cannot be removed from the module because of the flow obstacles presented by the webs.

Furthermore, part of the filter surface of the filter medium will not be available for filtration purposes, since no filtration occurs in the areas where the filter medium contacts the spacer.

On the other hand, the spiral wound-type filter modules show a relatively high packing density and are more cost-effective with respect to the available filter surface than the plate and frame modules.

Spiral wound-type modules are described, for example, in DE 100 51 168, U.S. Pat. No. 4,834,881 or DE 30 05 408.

The spacers proposed in U.S. Pat. No. 4,834,881 have the drawback that because of the corrugated ridges structure used, a defined distance between the spacer and the filter material surface is difficult to guarantee. This results in filtration properties which are not clearly predictable. In addition, the corrugated-type spacers block a substantial portion of the filter medium surface.

The object of the present invention resides in providing a spacer for filter modules which may be used not only for plate and frame filter modules but also for spiral wound-type filter modules and which allows high packing densities while providing optimized cleanability.

This object of the present invention is accomplished by a spacer for filter modules which is disposed between two layers of a filter medium, said spacer comprising an essentially flat structured sheet material having upper and lower projections on the upper and lower surfaces thereof, respectively, said upper and lower projections defining an upper and lower bearing face for the layers of filter medium, wherein said projections are rise from said upper and lower surfaces with wall portions and terminate in top portions, said upper and lower projections being spaced from each other in a direction parallel to the surface of the sheet material.

The present invention thus provides a spacer for filter modules which allows the creation of open flow channels in the filter modules in which the flow direction and velocity can be adapted to specific filtering applications.

The present invention further allows for modifications of the spacer which provide for a reduced tendency to fouling.

According to one embodiment of the present invention the wall portions of the projections are essentially vertically oriented with respect to the surface of the sheet material. Consequently, the flow channels have an essentially rectangular cross-section.

The projections may be provided as hollow structures. Such hollow structures are easily produced by deforming the sheet material.

According to a further embodiment of the present invention the projections are spaced from each other by flat areas of sheet material. This provides for relatively large unobstructed cross-sections of the flow channels.

Such flat areas of sheet material in between the projections may be provided with protrusions which may be advantageous to influence flow direction and velocity according to the specific needs of a filtering application. Generally, the height of the protrusion will be less than the height of the projections so as to reduce the cross-section of the flow channels at predefined positions.

The top portions of the projections may comprise rounded surface areas, especially where the top portions meet the wall portions, thus avoiding sharp edges on the projections which could result in wear of the filter medium layers contacting the projections.

The projections may be present in the form of elongated fins which, for example, may be embossed into the spacer sheet material. The shape of the fins may be straight, simply bent, in wave form or have zigzag configuration.

According to further modifications, the shape of the elongated fins may be rectangular, elliptical or rounded. This allows a further adaptation of the spacer to specific needs of a filtration application.

In an alternative embodiment of the present invention, the projections are in the form of continuous ribs the longitudinal direction of which is substantially parallel. The shape of the ribs may be straight, in wave form or have a zigzag configuration. This allows a further adaptation of the spacer to specific needs of a filtration application.

While the provision of elongated fins does not separate the voids volume between the surface of the spacer sheet material and the surfaces of the filter media, the parallel continuous rib projections will separate such voids volumes into separate channels.

According to the present invention, the projections in the form of elongated fins and the projections in the form of parallel continuous ribs can be oriented essentially parallel to the flow direction of the feed fluid. Alternatively, according to a further embodiment, the elongated fins can be oriented in a specific angle to the general flow direction to create a mixing of the fluid by the change of direction imparted on the fluid flow. In this case the projections are most preferably set with different angles to the general flow direction.

In another embodiment of the present invention, the projections are substantially in the form of punctiform areas. Especially preferred are projections in the form of cylindrical, rectangular, triangular or slightly tapered pins or studs. Other preferred projections may have drop form.

Again, the specific selection of the shape of the projections serves to meet specific requirements of a given filtering application.

In order for the spacer to provide a uniform support for the filter media, the upper and lower projections are distributed over the area of the sheet material of the spacer in a regular pattern.

Generally speaking, the distance between two adjacent upper projections is in the range of 2 to 50 mm, more preferably 3 to 30 mm. Even further preferred is a distance of from 4 to 10 mm, even more preferably of from 5 to 10 mm.

The same applies to the distance of two adjacent lower projections.

A preferred distance between adjacent upper and lower projections is at least 0.5 mm, more preferably 1 mm and most preferably 2 mm. A preferred distance between adjacent upper and lower projections is at most 25 mm, more preferred 15 mm and most preferred 4 mm.

Punctiform projections preferably have a diameter or apparent diameter in the range of 0.2 to 5 mm, more preferably 0.3 to 5 mm and most preferred 0.5 to 2 mm.

The preferred height of the projections of whatever specific type used is in the range of 0.1 to 1.5 mm, more preferably at least 0.2 mm. The maximum height of the projections is more preferably 1 mm and most preferred 0.5 mm.

The spacer sheet material may be made of a metal or plastic sheet material as this facilitates embossing of the projections thereon. The projections may also be manufactured in a separate step and subsequently bonded to the surfaces of the sheet material. However, embossing the sheet material to produce the projections is preferred since it can be carried out at lower cost. Likewise, it is feasible to produce the spacer including the projections in one production step.

Furthermore, the sheet material preferably used is a flexible sheet material so as to be usable for plate and frame type filter modules as well as spiral wound-type filter modules.

The sheet material may contain in addition perforations, especially in the flat areas extending between the projections. The perforations provide for small openings or through-holes in the sheet material, which allow exchange of feed fluid from the upper to the lower side of the sheet material and vice versa. In some applications such perforations have been found helpful in reducing concentration polarization effects. The proportion of the area of the flat portions of the sheet material remaining in between projections and, if present, between the protrusions used for providing the optional perforations preferably amounts to 5 to 50%. The perforations may in principle be selected from a great variety of shapes and can be, for example, round, elliptical or rectangular.

Between the described projections, which support the filter media, there can be additional protrusions inbetween. These are used as accelerators for the fluid velocity. Those additional protrusions have a lower height than the supporting projections and do not touch the filter media.

The spacer according to the present invention can therefore fulfil the following demands:
Spacer between the filter media sheets
wind tunnel for the fluid, directing the fluid flow
accelerator for the fluid velocity
openings equalizing fluid flow in top and bottom side channels, which may be used to create additional turbulences without decreasing the cross-section of the flow channels; in case of partial blockage of a flow channel, the openings provide for pressure equalization.

The projections may be formed in a simple embossing process when a plastic sheet material is used as the sheet material for the spacers.

The advantages of the spacers according to the present invention are the following:
area of reduced fluid flow may be essentially avoided, resulting in reduced tendency to deposition of contents of the fluid to be filtered;
in the direction of fluid flow, there are minimal or substantially no contact areas between the spacer and the filter material, which further reduces the tendency to fouling;
an unhindered fluid flow in the feed channels results in an improved ability to clean the filter media by flushing, since the removal of deposits is not obstructed by any structures of the spacer;
fluids containing a higher content of solid material can be treated, which heretofore has not been feasible with spiral wound-type filter modules;
pressure drop may be reduced because of the possibility to optimize fluid flow;
the spacer can also be used in plate and frame modules having an increased packing density.

The invention also relates to a filter module comprising two filtering layers of filter medium and a spacer as described hereinabove. The spacer is disposed between the filter medium layers.

Preferably, the spacer is disposed in the filter module in such a way that the longitudinal direction of the projections (if present) is essentially parallel to the direction of flow of a fluid to be filtered.

The present invention further relates to a spiral wound-type module containing the filter module as described hereinabove.

The present invention also relates to a plate and frame filter module which has been fabricated from the aforementioned filter modules.

The present invention further relates to the treatment of waste water, especially industrial waste water, using the aforementioned filter modules.

The invention also relates to methods of treatment of industrial process water, the treatment of leachate from landfills, the desalination of sea water as well as the treatment of surface and/or brackish water.

With all the aforementioned methods, the filter module may be used in the form of a spiral wound-type module or in the form of a plate and frame module.

These and other aspects and features of the present invention will now be described in detail with reference to the Figures containing various specific embodiments. Specifically the Figures show:

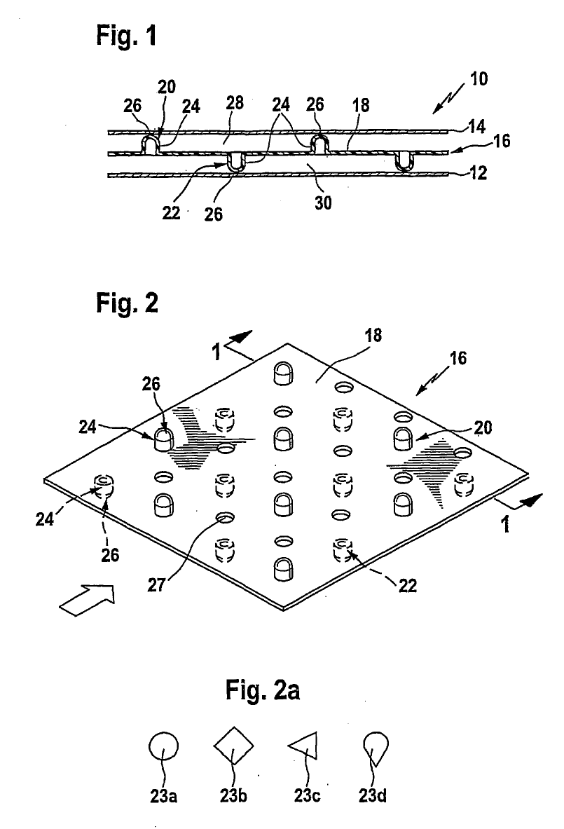

FIG. 1: a cross section of a filter module comprising a first embodiment of an inventive spacer with punctiform projections;

FIG. 2: a three-dimensional representation of the spacer of the embodiment of FIG. 1;

FIG. 2a: alternative configurations of the punctiform projections of the spacer of FIGS. 1 and 2;

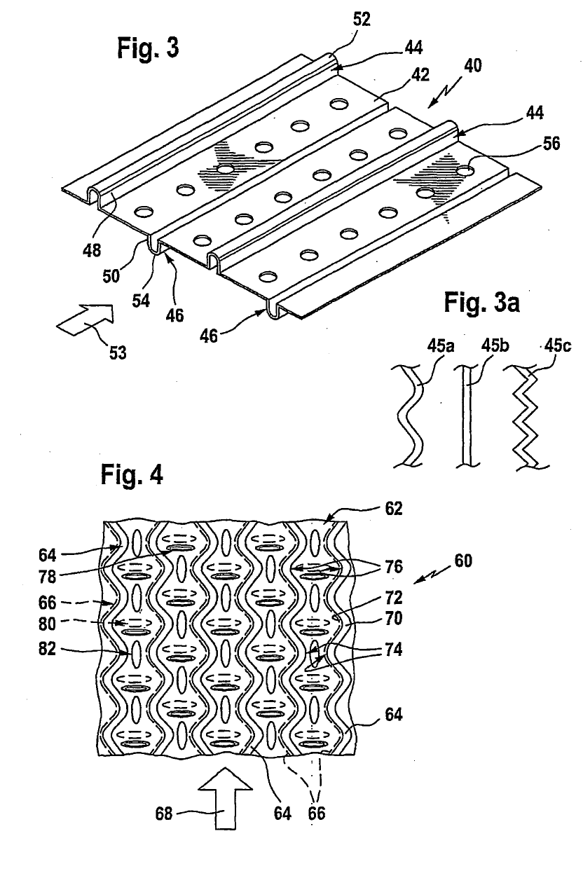

FIG. 3: a three-dimensional representation of a further embodiment of the spacer of the present invention with continuous projections;

FIG. 3a: alternative configurations of the continuous projections of the spacer of FIG. 3;

FIG. 4: a top view of a further embodiment of the spacer of the present invention;

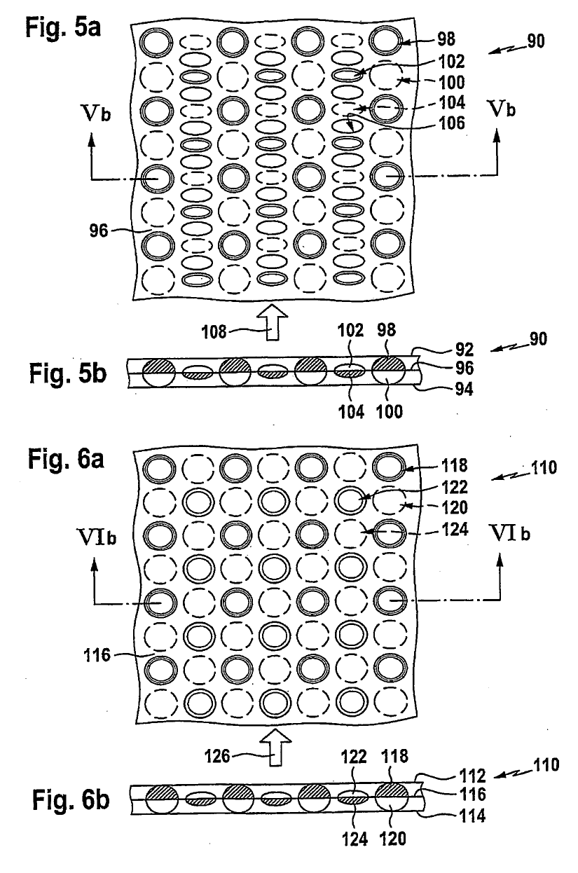

FIGS. 5a and 5b: a top view and a cross-sectional view of a further embodiment of the inventive spacer;

FIGS. 6a and 6b: a top view and a cross-sectional view of a further embodiment of the inventive spacer;

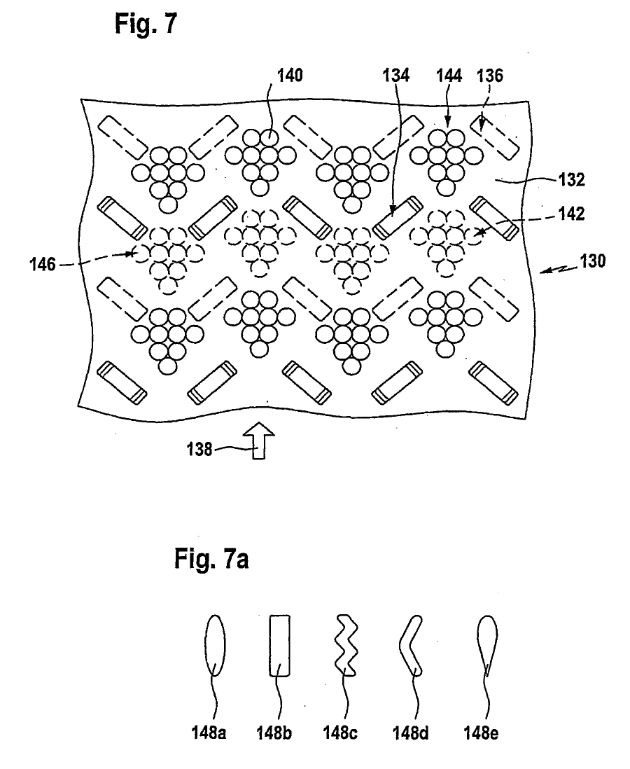

FIG. 7: a top view of a further embodiment of the inventive spacer with projections in the form of elongated fins;

FIG. 7a: alternative configurations of the projections of the spacer of FIG. 7;

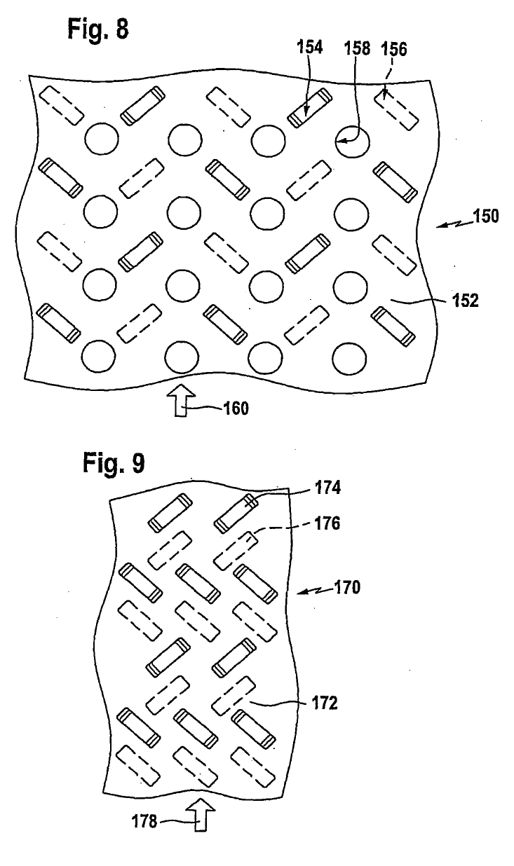

FIG. 8: a top view of a further embodiment of the inventive spacer;

FIG. 9: a top view of a further embodiment of the inventive spacer;

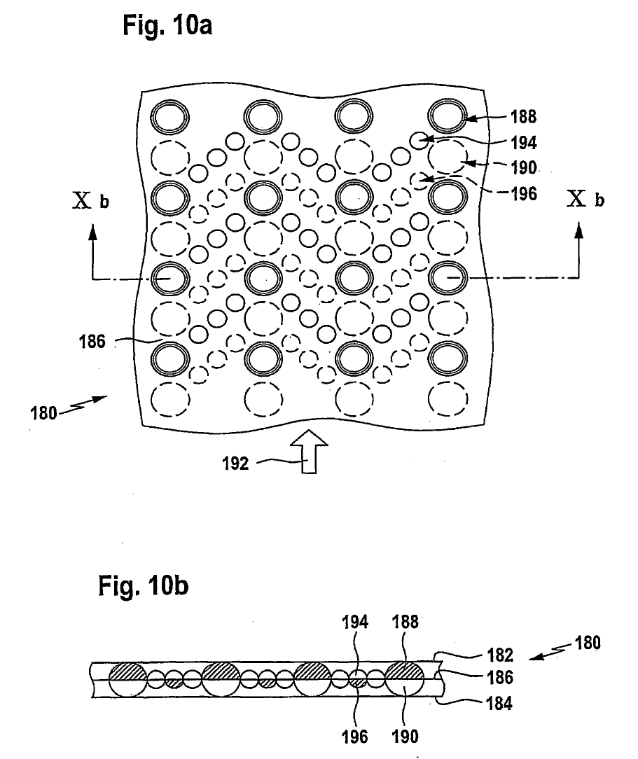

FIG. 10a and 10b: a top and a cross-sectional view of a further embodiment of the inventive spacer; and

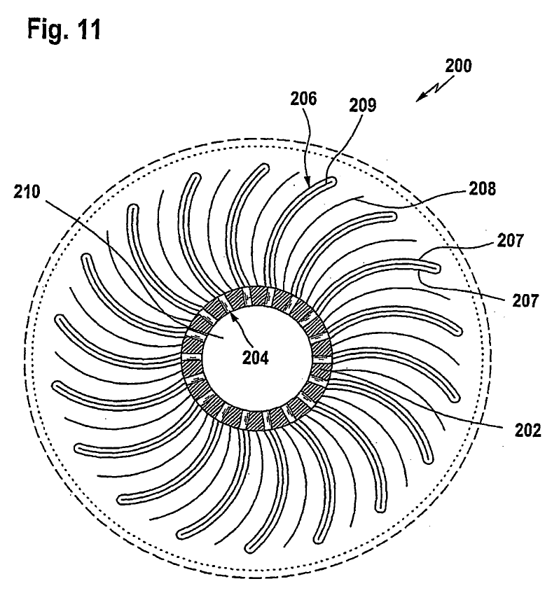

FIG. 11: schematic representation of a spiral-wound type module comprising the inventive spacer.

FIG. 1 shows schematically a filter module 10 composed of a first filter medium layer 12 and a second filter medium layer 14, the two filter medium layers 12 and 14 being spaced apart in parallel orientation via a spacer 16 comprised of a sheet material 18 having upper and lower projections 20, 22 rising from the upper and lower surface of the sheet material 18, respectively, to define upper and lower bearing faces for the layers of filter medium 12 and 14.

The projections 20 and 22 are in the form of punctiform pin or stud-like projections comprising cylindrical walls 24 and rounded top portions 26 which contact the filter medium layers 14 and 12, respectively.

Because of the perpendicular orientation of the cylindrical walls 24 with respect to the sheet material 18, no areas are created where a blocking of the feed flow is to be observed. Consequently, the tendency to fouling is greatly diminished.

Furthermore, the upper and lower projections are preferably arranged in a regular pattern.

The distance between two upper projections as shown in FIG. 1, is preferably in the range of from 2 to 30 mm, more preferably 4 to 10 mm. The same holds for the distance between two lower projections. The distances mentioned above and below are to be measured at the points where the wall portions of the projections meet the flat area of sheet material inbetween those projections.

The distance between two neighbouring projections may be made more narrow to provide for a higher number of obstacles to the fluid flow, thereby reducing the tendency of concentration polarization.

The distance between an upper and a lower projection is preferably in the range of 0.5 to 15 mm, more preferably 1 to 4 mm.

The diameter of the punctiform projections 22 and 20 is preferably in the range of 0.2 to 5 mm, more preferably 0.5 to 2 mm.

The height of the projections, i.e., the distance at which the filter medium layer 14, 12, respectively, is held from the surface of the sheet material 18, is preferably in the range of 0.1 to 1.5 mm, more preferably 0.2 to 0.5 mm.

Between the filter medium layers 14 and 12 and the interposed sheet material 18 an upper and a lower void volume 28, 30 is created which allows for fluid throughput with a minimum of flow resistance.

FIG. 2 shows schematically the spacer 16 of the filter module of FIG. 1 in a three-dimensional representation.

The sheet material 18 comprises projections 20 and 22 extending from the upper and lower surfaces of the sheet material 18, in upward and downward directions, respectively.

FIG. 2 shows more specifically that the projections are punctiform projections comprising cylindrical wall portions 24 and rounded top portions 26. The punctiform projections 20 and 22 may be embossed into the sheet material 18, for example, using two embossing rolls, between which the sheet material 18 passes while being heated in order to soften the sheet material 18.

Alternative shapes of the punctiform projections 20 and 22 are shown in FIG. 2a in a top view. Projection element 23a represents a shape of a hemisphere or part of it. Here the wall and top portions of the projections 20 and 22 seamlessly merge.

Projection element 23b has a rectangular cross-section with an essentially flat top portion which merges with the wall portions in a chamfered configuration. Of course, this projection element could also be equipped with a rounded surface area.

Projection element 23c is a further alternative shape for the projections 20 and 22 with a triangular cross-section and an essentially flat top portion which merges with the wall portions in a chamfered configuration. Again, the top portion may alternatively have a rounded surface area.

Projection element 23d shows a still further configuration for the projections 20 and 22 with the shape of a droplet.

The sheet material 18 may be optionally provided with perforations 27. The perforations 27 allow for feed fluid exchange from one side of the sheet material 18 to the other. In some applications such exchange is found to help decrease the tendency of concentration polarization. The perforations 27 are preferably located in the areas of the sheet material extending between the projections 20, 22. Although the perforations 27 are shown in FIG. 2 as circular holes, their shape may be greatly varied to achieve specific effects on the fluid flow.

A preferable material for manufacturing sheet material 18 is, for example, PVC or polyolefin polymer or sheet metal.

The advantages of this new spacer design are as follows:
open channel configuration in modules with high packing density at lower cost;
improved resistance to membrane fouling;
improved cleaning ability of the membrane enhancing lifetime of the modules;
maximum free membrane area for minimum disturbance and hindrance of fluid flow;
no or fewer dead zones in the feed channels;
high load applications are feasible with high packing density modules;
processing of highly sensitive fluids.

The inventive spacer may provide four functions simultaneously:

1) spacer
2) flow director
3) flow accelerator
4) equalizer

FIG. 3 shows schematically an alternative design of an inventive spacer in the form of spacer 40 which is composed of a sheet material 42 which has upper and lower projections 44 and 46 extending vertically from the upper and lower surfaces of the sheet material 42, respectively.

The projections 44 and 46 are in the form of parallel continuous ribs with vertical wall portions 48 and 50 extending from the respective surfaces of the sheet material 42. Furthermore, the tops of the ribs 44 and 46 have rounded portions 52 and 54 which allow for smooth contact between the spacer 40 and upper and lower sheets of filter medium (not shown). The longitudinal direction of the continuous ribs is essentially parallel to the general flow direction indicated by arrow 53.

Alternative designs for the continuous rib projections 44 and 46 are shown in FIG. 3a representing projection elements 45a, 45b and 45c.

The projection element 45a has in its top view a continuous wave form with or without vertically upstanding wall portions and a flat or rounded top portion. In any case, the top portion and the wall portions merge in a chamfered configuration or seamlessly merge, thereby avoiding sharp edges which could wear the filter media upon assembly and operation of the filter module.

The projection element 45b is similar in its configuration to the projections 44 and 46 as shown in FIG. 3, except that the wall portions have a curved cross-section and seamlessly merge with the rounded top portion surface area.

The projection element 45c has a zigzag top view configuration with or without vertically upstanding wall portions. In any case, the top portion and the wall portions merge in a chamfered configurations or seamlessly merge as is in the case of the projection element 45a.

The ribs 44 and 46 may be embossed into the sheet material 42 quite easily when the sheet material is made of a polymer material which is slightly heated for facilitating the embossing action of embossing rolls.

The distance between two upper ribs 44 is preferably in the range of 3 to 30 mm, more preferably, 5 to 10 mm. The distance between an upper and an adjacent lower projection 44 and 46, respectively, is preferably in the range of from 1 to 15 mm, more preferably, 2 to 4 mm.

The height of the ribs 44 and 46 is preferably in the range of 0.1 to 1.5 mm, more preferably 0.2 to 1 mm, while the widths of the ribs 44 and 46 is preferably in the range of 0.3 to 1.5 mm, more preferably 0.5 to 1 mm.

The areas of the sheet material 42 extending between the projections 44, 46 may optionally comprise perforations 56 providing through-holes for feed fluid exchange from the upper to the lower side of the sheet material and vice versa. This serves as a means to reduce the tendency of concentration polarization in some applications.

FIG. 4 shows another embodiment of the present invention in the form of spacer 60 made of a sheet material 62.

The sheet material 62 comprises upper and lower projections 64 and 66 which extend in parallel to a general fluid flow direction indicated by arrow 68. The projections 64 and 66 have a continuous wave form configuration as shown in FIG. 4 and are preferably embossed into the sheet material 62 in a process similar to the one described above with connection to the afore-described embodiments of the present invention.

The cross-sectional shape of the projections 64 and 66 may be such that wall portions of the projections 64 and 66 extend from the upper and lower surface of the sheet material 62, respectively, in an acute angle, which may reach 90° in certain variants and end in a top portion 70 and 72, respectively, which may be flat or of a curved or rounded configuration. In any case, the top portion 70 and 72 will merge with the wall portions of the projections 64 and 66 in a chamfered configuration so as to avoid any sort of sharp edges which could lead to wear of filter media contacting the top portions of the projections 64 and 66 during assembly and operation of a filter module produced using such type of spacers 60.

The embodiment shown in FIG. 4 uses a configuration of the upper and lower projections 64 and 66 where two neighbouring projections 64 and 66 directly merge into one another, i.e., the one wall portion of the upper projection 64 directly continues and merges with a wall portion of the projection 66, extending from the lower side of spacer 60.

In the configuration shown in FIG. 4, the upper and lower projection 64 and 66 are arranged as pairs, where one wall portion of the upper projection 64 directly meets with a wall portion of the lower projection 66 such that the upper and lower projections of one pair of projections are directly located next to one another. In such case, the upper and lower projection of one pair not separated by a flat area of sheet material.

Furthermore, the continuous wave form projections 64 and 66 are arranged such that two neighbouring projections 64 or two neighbouring projections 66 are positioned with respect to the flow direction 68 with an offset of half a wave length.

Thereby, the flow channels created by spacer 60 repeatedly become more narrow in the area where two wave crests 74 are facing one another, and wider where two wave troughs 76 are positioned opposite to one another.

By such a configuration, the velocity of fluid flow constantly varies creating turbulences which help to avoid concentration polarization.

Furthermore, spacer 60 may be modified by introducing upper protrusions 78 and lower protrusions 80 which are designed to create further turbulence and the fluid flows along the flow channels defined by the projections 66 and 64, respectively.

The protrusions 78, 80 may have the elongated shape as shown in FIG. 4. This shape may be modified so as to make the protrusions resemble the configurations shown for the projections in FIGS. 2a and 7a.

Preferably, the upper and lower protrusions 78, 80 are positioned along the length of the flow channels of spacer 60 such that they occupy an area inbetween two wave troughs 76. With respect to the direction of fluid flow as indicated by arrow 68, the upper and lower protrusions may be arranged one behind the other, or they may be positioned exactly at the same position along the length of the flow direction.

Furthermore, the spacer according to FIG. 4 may be further modified by providing small perforations 82 in the sheet material 62 which in case of the specific example given in FIG. 4 are extended oval perforations which are arranged in their larger aspect in parallel to the flow direction 68.

Again, FIG. 4 shows a specific positioning of the perforations 82, namely inbetween two neighbouring wave crests 74, i.e., at a position along the length of a flow channel created between two neighbouring projections 66 and 64, respectively, where the channel cross-section is smallest.

At this point, a maximum use of the perforations with respect to their ability to create turbulences and to provide for pressure equalization is made.

As apparent from FIG. 4, the perforations 82 have an elongated or elliptical shape and are oriented with their greatest aspect in parallel to the flow direction 68.

In contrast, the upper and lower protrusions 78 and 80 have an orientation with their greatest aspect perpendicular to the flow direction 68. This provides for a maximum effect with regard to decreasing of polarization problems.

FIGS. 5a and 5b show a further embodiment of the present invention in the form of spacer 90.

Whereas FIG. 5a shows a top view of spacer 90, FIG. 5b shows a cross-section along line Vb-Vb of FIG. 5a.

The spacer 90 is shown in FIG. 5b inbetween an upper and lower filter media 92, 94 and is formed from a sheet material 96 which has been provided in an embossing process with spherical upper and lower protrusions 98, 100.

The upper and lower protrusions 98, 100 are alternatingly aligned in parallel rows and are spaced from one another by flat sheet material areas.

The flat sheet material areas inbetween the upper and lower protrusions 98 and 100 are provided with upper and lower protrusions 102, 104 which are formed in alternating sequence in parallel rows which are arranged inbetween two neighbouring rows of upper and lower protrusions 98, 100.

Additionally, the sheet material 96 is provided with perforations 106 which are interposed within a row of upper and lower protrusions 102 and 104.

While the upper and lower projections 98 and 100 have the function to essentially direct the fluid flow between the sheet material 96 and the filter media 92 and 94, the protrusions 102 and 104 as well as the perforations 106 serve to influence the velocity of the fluid flow and/or to create turbulences in order to minimize concentration polarization and deposition of contents of the fluid to be filtered. Furthermore, the perforations 106 serve to equalize the pressure on the upper and lower side of the sheet material 96 and may in addition serve to create turbulences in the fluid flow, the general direction of which is indicated by arrow 108.

A similar embodiment is shown in FIGS. 6a and 6b which represent a spacer 110 inbetween a filter media 112 and 114. The spacer 110 is made of a sheet material 116 which has been provided similar to the embodiment shown and described in FIGS. 5a and 5b with upper and lower projections 118, 120 which are arranged in alternating sequence in parallel rows, which are spaced apart by flat sheet material 116. Inbetween the parallel rows of upper and lower projections 118, 120, upper and lower protrusions 122, 124 are arranged in alternating sequence in parallel rows, which in contrast to the embodiment of FIGS. 5a and 5b are also of spherical or lenticular shape. In contrast to the embodiment shown in FIGS. 5a and 5b, the embodiment of FIGS. 6a and 6b does not have perforations connecting the upper side of the sheet material 116 to the lower side thereof. The parallel rows of upper and lower projections 118, 120 and upper and lower protrusions 122, 124 are in parallel with the general flow direction of the fluid to be filtered which is indicated by an arrow 126.

As in the embodiment of FIGS. 5a and 5b, the upper and lower projections 118, 120 serve to support the filter media 112, 114 whereas the upper and lower protrusions 122, 124 serve to increase the flow velocity at specific points of the spacer 110 to create turbulences in order to minimize concentration polarization effects.

FIG. 7 shows another embodiment of an inventive spacer according to the present invention, which is denoted with reference numeral 130. The spacer 130 comprises a sheet material 132 which is provided with upper and lower projections 134, 136 which have the form of elongated fins.

The direction of the greatest aspect of the elongated fins 134, 136 is oblique to the general flow direction as indicated by arrow 138. Again, the upper and lower projections 134, 136 are arranged in parallel with an alternating sequence of upper and lower projections, such parallel rows being spaced from one another as are the upper and lower projections 134, 136 by flat areas of sheet material 132.

The areas of sheet material 132 separating the individual upper and lower projections 134, 136 are provided with upper and lower protrusions 140, 142, which are of spherical form. The upper and lower protrusions 140, 142 are arranged in alternating sequence in parallel rows such rows being positioned in between parallel rows of upper and lower projections 134, 136.

The specific embodiment of FIG. 7 shows that the upper and lower protrusions 140, 142 may be provided as a multitude of protrusions forming specifically arranged clusters 144, 146.

The specific shape of the elongated fins or upper and lower projections 134, 136 is of rectangular configuration with wall portions rising essentially vertically from the surfaces of the sheet material 132, ending in top portions which are essentially flat. The top portions merge with the wall portions of the upper and lower projections in a chamfered fashion so as to avoid sharp edges which could wear the filter material (not shown in FIG. 7).

FIG. 7a shows four alternative configurations of the projections 134, 136 in the form of projection elements 148a to 148e. The projection element 148a has an essentially elliptical form and a cross-section derived from a partial lenticular shape.

Projection element 148b shows an essentially rectangular top view, whereas the cross-sections shape is derived from partial cylindrical form.

Projection element 148c shows a wave form in a top view and may comprise vertically rising wall portions with a flat top or rounded top portion or may be in cross-section of a rounded shape with oblique wall portions directly merging with the top portion of the projection element 148c.

Projection element 148d as a partial wave form with vertically rising wall portions and flat rounded top portion or with obliquely rising wall portions and seamlessly merging top portion.

Projection element 148e is similar in its shape to projection element 148a. However, one end thereof is not rounded but terminates in a pointed tip.

The various configurations of the projection elements as indicated in FIG. 7a and also as represented by the upper and lower projections 134 and 136 of FIG. 7 demonstrate the ease with which the form of the projections may be adapted to a specific needs for a filtering application.

FIGS. 8 and 9 show variants of the basis structure of an inventive spacer according to FIG. 7.

In FIG. 8 a spacer 150 is shown comprising a sheet material 152 comprising upper and lower projections 154, 156 in alternating sequence arranged in parallel rows. The parallel rows of upper and lower projections 154, 156 are spaced apart as are the upper and lower projections 154, 156 by flat areas of the sheet material 152.

These flat areas of sheet material 152 comprise in contrast to the embodiment shown in FIG. 7 no protrusions on the upper and lower surface, but a sequence of equally spaced perforations 158 which are of a circular configuration. These perforations are arranged in parallel rows which are interposed between neighbouring rows of upper and lower projections 154, 156.

The rows of alternating upper and lower projections 154, 156 as well as the rows of perforations 158 are arranged in parallel to the general flow direction which is indicated by an arrow 160. Again, the upper and lower projections are arranged in an obliqued direction to the general flow direction 160. The shape of the upper and lower projections 154, 156 are that of elongated fins as explained in connection with FIG. 7. Alternative shapes may be used as indicated in the form of projection elements 148a to 148d as shown in FIG. 7a.

Also the form of the perforations 158 may vary greatly and may be, for example, of elongated elliptical shape, similar to what is shown in FIG. 5a or FIG. 4, depending on the specific filtering application.

A further difference of the embodiment of FIG. 8 to the embodiment shown in FIG. 7 is that the parallel rows of alternating upper and lower projections 154, 156 are arranged such that upper and lower projections 154, 156 are arranged in alternating sequence in parallel rows in a transverse direction to the general flow direction 160.

In the embodiment shown in FIG. 7, the upper projections 134 and the lower projections 136 form separate parallel rows when viewed in a direction trans-verse to the general flow direction 138.

A further embodiment of the present invention is shown in the form of a spacer 170 in FIG. 9.

Here, the inventive spacer is shown in its simplest configuration with a sheet material 172 comprising upper and lower projections 174, 176. The upper and lower projections are arranged obliquely to the general flow direction 178 in parallel rows of upper projections 174 and lower projections 176 in a direction transverse to the general flow direction 178. The arrangement of the individual rows of upper projections 174 and lower projections 176, respectively, is such that their staggered configuration on the upper side of the sheet material 172 and on the lower side thereof. The form of the projections 174 and 176 as represented in FIG. 9 is of the configuration of elongated fins as explained in connection with FIG. 7. The variants possible also in this embodiment of the present invention are shown as projection elements 148a to 148d represented in FIG. 7a.

In contrast to the embodiments of FIG. 8 and FIG. 7, this spacer does not comprise protrusions or perforations but it is obvious that upon a less dense arrangement of projections 174 and 176 perforations and/or protrusions may be included in the design of a spacer 170 as shown in FIG. 9.

In FIGS. 10a and 10b another embodiment of the present invention in the form a spacer 180 is shown.

While FIG. 10a shows a top view, the spacer 180 is shown in FIG. 10b in a cross-sectional view, which includes filter media 182 on the upper side of spacer 180 and a filter media 184 on the lower side thereof. The spacer 180 is arranged in between these two filter media 182 and 184 and comprises a sheet material 186 which is provided with spherical upper and lower projections 188, 190 which are arranged in alternating sequence in parallel rows, such rows being parallel to a general flow direction indicated by arrow 192. The upper and lower projections as well as the parallel rows of alternating upper and lower projections 188, 190 are separated by flat areas of sheet material 186.

The areas of flat sheet material 186 inbetween the parallel rows of alternating upper and lower projections 188, 190 comprise upper and lower spherical protrusions 194, 196. In contrast to some of the embodiments shown before, a flat area of sheet material 186 inbetween neighbouring rows of projections and neighbouring projections 188 and 190, respectively, does not comprise a single protrusion 194, 196, respectively, but comprises a multiplicity of such protrusions which in the present embodiment shown in FIG. 10a/FIG. 10b are arranged in parallel rows, the direction of which is obliquely arranged with respect to the general flow direction 192.

In addition, the spacing of the upper and lower protrusions 194, 196 with respect to one another and also the spacing to the upper and lower projections, respectively, is such that when seen in a cross-sectional as represented by FIG. 10b, the upper and lower projections as well as the upper and lower protrusion deem to meet one another.

This means that the fluid flow is influenced and directed by the upper and lower projections as well as the upper and lower protrusions over the whole of the cross-section of the space limited by the filter media 182 and 184.

From the above description of the various embodiments of the present invention, it is clear that this design of an inventive spacer 180 may be easily combined in addition with a pattern of perforations if that is required by a specific filtering application.

In the present embodiment the direction of the fluid flow of specific areas of a filter module created by filter media 182 and 184 as well as the spacer 180 is provided by the upper and lower projections as well as the surface area of the flat portions of the sheet material 186. The upper and lower protrusions 194, 196 serve to vary the flow velocity of the fluid to be filtered and specific portions of the fluid channels in order to counteract concentration polarization and to create turbulences in addition to what is created already by the upper and lower projections in order to avoid deposit of contents of the fluid to be filtered on top of the sheet material 168 and/or the surfaces of the filter material 182, 184 facing the spacer 180.

While various of the above-described Figures include cross-sectional views to envisage the arrangement of the inventive spacers within a filter module which comprises the spacer itself and an upper and lower layer of filter media, it is readily understood that all of the spacers described with reference to the afore-going Figures may be provided in a filter module configuration as shown in such cross-sections.

The filter modules provided with such spacers and corresponding filter media at top and bottom of the spacer may be used in filter stacks or in spirally wound type filter modules.

For the spirally wound filter modules there are in principle two different types available, both of which include a central cylindrical rod to which at least one filter element and at least one inventive spacer are attached. The rod, around which the one or more filter elements together with the one or more spacers are spirally wound will have a filtrate channel to receive the filtrate from the filter element or filter elements. While the simplest type of the spirally wound filter module is easily envisaged and is therefore not shown in the Figures, the more complex configuration with a multiplicity of filter elements is shown in schematical representation in FIG. 11.

FIG. 11 shows a filter module 200 including a cylindrical hollow rod 202 comprising a number of openings 204 in the form of through holes which are arranged equidistantly around the perimeter of cylindrical rod 202.

The filter module 200 furthermore comprises a plurality of filter elements 206 each comprising two layers of filter media 207, e.g., microporous membranes, with an interposed draining layer 209. The two layers of filter media 207 and the interposed draining layer 209 are sealed at their edges (not shown in detail in FIG. 11).

At one edge these filter elements 206 comprise at least one outlet opening which corresponds to an opening 204 on the periphery of the central cylindrical hollow rod 202.

The filter elements are fixed with said one edge comprising such opening(s) to the outer periphery of the central rod 202 in a manner which ensures fluid communication of their openings with the openings 204 and hence with a filtrate channel 210 provided within central rod 202.

Inbetween two filter elements 206, spacers 208 according to the present invention are fixed to the outer periphery of the rod 202, the spacers 208 being of the design according to the present invention as, for example, described in connection with one of the FIGS. 1 to 10 of the present specification.

Once the filter elements 206 and spacers 208 are arranged in the configuration as schematically indicated in FIG. 11, they are tightly wound around the central rod 202 to form a compact filter module 200 which may then be inserted into a cylindrical housing (not shown in FIG. 11) having an inlet and an outlet for the fluid to be filtered. The housing furthermore includes an outlet for the filtrate which is in fluid communication with the inner space of the central rod 202 forming filtrate channel 210.

In the operation of the filter module 200, fluid flow is directed perpendicular to the plane of the drawing of FIG. 11 in the area outside of the peripheral surface of central rod 202. The portion of the fluid to be filtered penetrates the membranes of the filter elements 206 and is drained via the drainage layer 209 of the filter elements 206 and their openings communicating with the openings 204 of the central rod. Furthermore, the filtrate is then drained via the filtrate channel 210 of rod 202 and the corresponding outlet of the housing of the filter module 200.

From the foregoing description it will be clear that a multitude of different forms of projections are feasible in accordance with the present invention without departing from the basic concept underlying the present invention.

Likewise the preferably provided protrusions may be selected from a broad variety of configurations.

Also the perforations may have various shapes, which are not limited to the ones shown in the Figures.

All such variations may be freely combined to adapt the inventive spacer and the filter module incorporating same to the specific needs of a filtration application.

1. A spacer for filter modules which is disposed between two layers of a filter medium, said spacer comprising an essentially flat structured sheet material having upper and lower surfaces and upper and lower projections on the upper and lower surfaces thereof, respectively, said upper and lower projections defining an upper and lower bearing face for the layers of filter medium, wherein said projections rise from said upper and lower surfaces with wall portions and terminate in top portions, said upper and lower projections being spaced from each other in a direction parallel to the surface of the sheet material.

2. The spacer according to claim 1, wherein the wall portions of said projections are essentially vertically oriented with respect to the upper and lower surfaces of the sheet material.

3. The spacer according to claim 1, wherein the projections are hollow structures.

4. The spacer according to claim 1, wherein the upper and lower projections, respectively, are spaced from each other by flat areas of sheet material.

5. The spacer according to claim 4, wherein the flat areas include protrusions, said protrusions having a height which is less than the distance between the surface of the sheet material and the bearing face of the projections.

6. The spacer as defined in claim 1, wherein the top portions of the projections comprise rounded surface areas.

7. The spacer as defined in claim 1, wherein said projections are in the form of elongated fins.

8. The spacer as defined in claim 1, wherein said projections are in the form of parallel continuous ribs.

9. The spacer as defined in claims 7, wherein the projections have a longitudinal direction and the longitudinal direction of said projections is oriented essentially parallel to the flow direction of the feed fluid.

10. The spacer as defined in claim 1, wherein said projections are substantially in the form of punctiform areas.

11. The spacer as defined in claim 10, wherein said projections are in the form of cylindrical studs.

12. The spacer as defined in claim 1, wherein said upper and lower projections are distributed in a regular pattern over the area of the sheet material.

13. The spacer as defined in claim 1, wherein upper and lower projections are arranged in pairs, one wall portion of the upper projection being directly connected to a wall portion of the lower projection.

14. The spacer as defined in claim 1, wherein the sheet material is made of a plastic material or metal.

15. The spacer as defined in claim 14, wherein the plastic material is a reinforced plastic material.

16. The spacer as defined in claim 14, wherein the projections are unitary with the sheet material.

17. The spacer as defined in claim 1, wherein the projections are bonded to the surface of the sheet material.

18. The spacer as defined in claim 1, wherein the sheet material is a flexible sheet material.

19. The spacer as defined in claim 1, wherein the sheet material comprises perforations in the areas of the sheet material extending between the projections.

20. The spacer as defined in claim 1, wherein the distance between two adjacent upper projections is in the range of 2 to 50 mm.

21. The spacer as defined in claim 1, wherein the distance between two adjacent lower projections is in the range of 2 to 50 mm.

22. The spacer according to claim 1, wherein the distance between an upper and a lower projection is in the range of 0.5 to 25 mm.

23. The spacer according to claim 1, wherein the projections have a punctiform shape with a diameter in the range of 0.2 to 5 mm.

24. A filter module comprising two filtering layers and a spacer as defined in claim 1 disposed between said filtering layers.

25. The filter module as defined in claim 24, wherein said spacer is disposed in the filter module such that the longitudinal direction of the projections is parallel to the direction of flow of a fluid being filtered by said filter module.

26. A spiral wound-type module, containing a filter module as defined in claim 24.

27. A plate and frame module made of filter modules as defined in claim 24.

28. The method of claim 36 comprising treating waste water by passing the waste water through the module.

29. The method of claim 36 comprising treating industrial process water by passing the industrial process water through the module.

30. The method of claim 36 comprising treating leachate from landfills by passing the leachate from landfills through the module.

31. The method of claim 36 comprising desalinating sea water by passing the sea water through the module.

32. The method of claim 36 comprising treating surface water by passing the surface water through the module.

33. The method of claim 36 comprising treating brackish water by passing the brackish water through the module.

34. The method as defined in claim 36, wherein the filter module used is in the form of a spiral wound-type module.

35. The method as defined in claim 36, wherein the filter module used is in the form of a plate and frame module.

36. A method of processing fluid comprising passing the fluid through the filter module as defined in claim 24.

37. The spacer as defined in claim 20 wherein the distance between two adjacent upper projections is in the range of 4 to 10 mm

38. The spacer as defined in claim 20 wherein the distance between two adjacent lower projections is in the range of 4 to 10 mm.
